(19) United States
(12) Patent Application Publication
(10) Pub. No.: US 2025/0209478 A1
(43) Pub. Date: Jun. 26, 2025

(54) AI MATURITY SCORING

(71) Applicant: HG Insights, Inc, Santa Barbara, CA (US)

(72) Inventors: Robert J. Fox, Santa Barbara, CA (US); Lauren Wong, Santa Barbara, CA (US)

(21) Appl. No.: 18/391,177

(22) Filed: Dec. 20, 2023

(51) Int. Cl. G06Q 30/0202

(52) U.S. Cl. CPC G06Q 30/0202

(57) ABSTRACT

AI maturity scoring implementations that are described herein generally assess the degree of immersion an entity has in AI matters. The AI maturity score for an entity is a combination of three components, namely an AI component, a data science component, and a data maturity component. The AI component quantifies the level of use of AI technologies at the entity. The data science component quantifies the level of an entity's data science expertise on a location basis. And the data maturity component quantifies the degree to which the entity is involved in using data technologies. An AI maturity report is also generated that includes a listing of, for each entity of interest, the AI maturity score computed for that entity.

### BACKGROUND

Advertisers, product manufacturers and technology vendors continually seek ways to identify potential customers who may purchase their products. This allows these businesses to better target potential customers. For example, the demand for Artificial Intelligence (AI) software products is increasing rapidly. AI software products are used for deep learning, computer vision, natural language processing, machine learning, cloud computing, content generation, and more. Having knowledge of who is more likely to buy AI software products will ultimately lead to more sales. One way to assess the likelihood of a potential customer buying AI software products is to determine the AI maturity of the customer. AI maturity refers to the level of development, adoption, and optimization of AI capabilities within an organization. The more AI mature an organization is, the more likely they may be to purchase AI software products.

It is noted that this background solely provides context for the disclosure to follow. It does not describe prior art related to the claims or constitute an admission of the existence of such prior art.

### SUMMARY

Artificial intelligence (AI) maturity scoring implementations described herein generally assess the degree of immersion an entity has in AI matters. One exemplary implementation takes the form of a system for AI maturity scoring which includes an AI maturity scorer having one or more computing devices, and an AI maturity scoring computer program having a plurality of sub-programs executable by the computing device or devices. The sub-programs configure the computing device or devices to access data from a database. This database includes a plurality of records having data including job titles, job descriptions, job locations, functional areas of an entity, dates, and entity information. The records of the database, including any metadata that is associated with a record, are scanned to identify entities of interest. For each entity of interest, an AI component that quantifies the level of use of AI technologies at the entity under consideration is computed, along with a data science component that quantifies the level of an entity's data science expertise on a location basis, and a data maturity component that quantifies the degree to which the entity is involved in using data technologies. An AI maturity score is then computed based on the AI component, data science component, and data maturity component. An AI maturity report is generated that includes a listing of, for each entity of interest, the AI maturity score computed for that entity.

Another exemplary implementation includes sub-programs that configure the computing device or devices to access data from the aforementioned database. The records of the database, including any metadata that is associated with a record, are scanned to identify for each record, a date representing the latest date information in the record is likely to be valid. The identified data is assigned to the record as the date of the record. The database records are then divided into groups based on which period of time the assigned date of the record falls. The periods of time are sequential, each cover a prescribed-length period of time, and include a current time period and one or more previous time periods. Next, the records of the database, including any metadata that is associated with a record, are scanned to identify entities of interest. Then, for each entity of interest, and each time period, an AI component that quantifies the level of use of AI technologies at the entity under consideration is computed, along with a data science component that quantifies the level of an entity's data science expertise on a location basis, and a data maturity component that quantifies the degree to which the entity is involved in using data technologies. An AI maturity score is then computed based on the AI component, data science component, and data maturity component. An AI maturity report is then generated that includes a separate listing of, for each entity of interest, the AI maturity score computed for that entity for each time period.

Yet another exemplary implementation takes the form of a computer-implemented process for scoring AI maturity. This process uses one or more computing devices to perform a number of actions. If a plurality of computing devices is employed, the computing devices are in communication with each other via a computer network. The first of the action involves accessing data from a database. The database includes a plurality of records with data including job titles, job descriptions, job locations, functional areas of an entity, dates, and entity information. The records of the database, including any metadata that is associated with a record, are scanned to identify entities of interest, software products and to identify locations associated with each entity of interest. It is also determined which of the software products identified in the scan are AI products. In one version, this is done using an AI product listing that includes a listing of software products that have been previously identified as involving AI. Each database record containing a software product found to match an AI product is tagged as an AI product-containing record. Next, for each entity of interest, an AI component that quantifies the level of use of AI technologies at the entity under consideration is computed. This involves computing an AI product use factor which quantifies the use of AI products by the entity under consideration in terms of the AI technologies the AI products represent, computing a percentage of locations associated with the entity under consideration that are using at least one AI technology, and computing a percentage of functional areas of interest across all locations associated with the entity under consideration that are using at least one AI technology. The AI component for the entity under consideration is then computed by adding the square of the AI product use factor computed for the entity under consideration to the percentage of locations of the entity using at least one AI technology and the percentage of functional areas of interest associated with the entity using at least one AI technology. Next, for each entity of interest, a data science component that quantifies the level of an entity's data science expertise on a location basis is computed. In one version, this involves, for each of the identified locations associated with the entity under consideration, identifying the data-oriented roles of individuals working for the entity at that location, determining how many different locations associated with the entity under consideration have at least one data-oriented role associated with it, and dividing the number of locations that have at least one data-oriented role associated with it by the total number of locations associated with the entity to produce a percentage of an entity's locations associated with a data-oriented role. In addition, the number of each type of data-oriented role associated with the entity under consideration, regardless of location, is determined, and the data-oriented role having the highest total is identified. A prescribed data-oriented role weight corresponding to the identified data-oriented role having the highest total is then assigned to the entity under consideration. This data-oriented role weight assigned to the entity under consideration is multiplied by the percentage of the entity's locations associated with a data-oriented role to produce the data science component for the entity under consideration. A raw data maturity component that quantifies the degree to which the entity is involved in using data technologies is also computed for each entity of interest. In one version, this is accomplished by first generating a list of software products in use by the entity under consideration. The list is then filtered to retain those software products that are also found in a data mature products listing to produce a list of data mature products in use by the entity under consideration. The data mature products listing lists the names of software products considered to be data mature products and a weight associated with each data mature product indicative of the level of pervasiveness of the product among entities deemed to be data mature. Next, the weight associated with each of the data mature products in the entity under consideration's list of data mature products is found using the data mature products listing and the weights are summed to produce a data maturity impact score for the entity under consideration. It is then determining how many different locations associated with the entity under consideration use at least one data mature product, and this number is divided by the total number of locations associated with the entity to produce the percentage of locations of the entity under consideration using at least one data mature product. The data maturity impact score computed for the entity under consideration is then multiplied by the percentage of locations of the entity under consideration using at least one data mature product to produce a raw data maturity component for the entity under consideration. For each entity of interest, the raw data maturity component computed for entity under consideration is normalized in view of the raw data maturity components computed for all the entities of interest to produce the data maturity component for the entity under consideration. Then, for each entity of interest that has a non-zero AI component, an AI maturity score is computed by summing the AI component, the data science component, and the data maturity component computed for the entity under consideration to produce the AI maturity score for the entity. However, for each entity of interest that has a zeroed AI component, the AI maturity score is computed by summing the data science component and the data maturity component computed for the entity under consideration and taking the square root of the sum to produce an AI maturity score for the entity under consideration. An AI maturity report is then generated that includes a listing of, for each entity of interest, the AI maturity score computed for that entity.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the AI maturity scoring implementations described herein will become better understood with regard to the following description, appended claims, and accompanying drawings where:

FIG. 1 is a diagram illustrating one implementation, in simplified form, of a system framework for realizing the AI maturity scoring implementations described herein.

FIG. 2 is a diagram illustrating one implementation, in simplified form, of the sub-programs included in the AI maturity scoring computer program which compute the AI component for entities of interest.

FIG. 3 is a flow diagram illustrating an exemplary implementation, in simplified form, of a process for computing an AI product use factor for each entity of interest.

FIG. 4 is a flow diagram illustrating an exemplary implementation, in simplified form, of a process for computing the percentage of locations of the entity under consideration using at least one AI technology.

FIG. 5 is a flow diagram illustrating an exemplary implementation, in simplified form, of a process for computing the percentage of functional areas across all locations of an entity using products associated with at least one AI technology.

FIG. 6 is a flow diagram illustrating an exemplary implementation, in simplified form, of a process for computing the AI component for an entity using the entity's AI product use factor, percentage of locations of the entity under consideration using at least one AI technology and percentage of functional areas across all locations of an entity using products associated with at least one AI technology.

FIG. 7 is a diagram illustrating one implementation, in simplified form, of the sub-programs included in the AI maturity scoring computer program which compute the data science component for each entity of interest.

FIG. 8 is a flow diagram illustrating an exemplary implementation, in simplified form, of a process for computing the percentage of an entity's locations that are associated with a data-oriented role.

FIG. 9 is a flow diagram illustrating an exemplary implementation, in simplified form, of a process for computing a data science weight for an entity.

FIG. 10 is a flow diagram illustrating an exemplary implementation, in simplified form, of a process for computing the data science component for an entity using the entity's percentage of an entity's locations that are associated with a data-oriented role and its data science weight.

FIG. 11 is a diagram illustrating one implementation, in simplified form, of the sub-programs included in the AI maturity scoring computer program which compute the data maturity component for each entity of interest.

FIG. 12 is a flow diagram illustrating an exemplary implementation, in simplified form, of a process for computing the data maturity impact score for an entity of interest.

FIG. 13 is a flow diagram illustrating an exemplary implementation, in simplified form, of a process for computing the percentage of an entity's locations associated with data mature product use.

FIG. 14 is a flow diagram illustrating an exemplary implementation, in simplified form, of a process for computing the data maturity component for an entity using the entity's data maturity impact score and the percentage of an entity's locations associated with data mature product use.

FIG. 15 is a diagram illustrating one implementation, in simplified form, of the sub-programs included in the AI maturity scoring computer program which compute the AI maturity score for each entity of interest.

FIG. 16 is a flow diagram illustrating an exemplary implementation, in simplified form, of a process for computing the AI maturity score for an entity of interest that has a non-zero AI component.

FIG. 17 is a flow diagram illustrating an exemplary implementation, in simplified form, of a process for computing the AI maturity score for an entity of interest that has a zeroed AI component.

FIG. 18 is a simplified example of one implementation of an AI maturity scoring report.

FIGS. 19A-E are a flow diagram illustrating an exemplary implementation, in simplified form, of a process for scoring AI maturity of entities of interest.

FIG. 20 is a diagram illustrating a simplified example of a general-purpose computer system on which various implementations and elements of the AI maturity scoring technique, as described herein, may be realized.

### DETAILED DESCRIPTION

In the following description of AI maturity scoring implementations reference is made to the accompanying drawings which form a part hereof, and in which are shown, by way of illustration, specific implementations in which the AI maturity scoring can be practiced. It is understood that other implementations can be utilized, and structural changes can be made without departing from the scope of the AI maturity scoring implementations.

It is also noted that for the sake of clarity specific terminology will be resorted to in describing the AI maturity scoring implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “some implementations”, or “one tested implementation”; or “one version”, or “another version”, or an “exemplary version”, or an “alternate version”, or “some versions”, or “one tested version”; or “one variant”, or “another variant”, or an “exemplary variant”, or an “alternate variant”, or “some variants”, or “one tested variant”; means that a particular feature, a particular structure, or particular characteristics described in connection with the implementation/version/variant can be included in one or more implementations of the AI maturity scoring. The appearances of the phrases “in one implementation”, “in another implementation”, “in an exemplary implementation”, “in an alternate implementation”, “in some implementations”, “in one tested implementation”; “in one version”, “in another version”, “in an exemplary version”, “in an alternate version”, “in some versions”, “in one tested version”; “in one variant”, “in another variant”, “in an exemplary variant”, “in an alternate variant”, “in some variants” and “in one tested variant”; in various places in the specification are not necessarily all referring to the same implementation/version/variant, nor are separate or alternative implementations/versions/variants mutually exclusive of other implementations/versions/variants. Yet furthermore, the order of process flow representing one or more implementations, or versions, or variants of the AI maturity scoring does not inherently indicate any particular order nor imply any limitations thereto.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” and variants thereof, and other similar words are used in either this detailed description or the claims, these terms are intended to be inclusive, in a manner similar to the term “comprising”, as an open transition word without precluding any additional or other elements.

It is also noted that for the purposes of the following description and claims, the term “entity” generally refers to a natural entity such as an individual person; a business entity such as an association, corporation, partnership, company, proprietorship, or trust; or a governmental entity such as a university or institute; among others. In addition, the term “functional area” of an entity generally refers to a department, group, team, branch, division, unit, section, or any other sub-part of a company.

### 1.0 AI Maturing Scoring

The Artificial Intelligence (AI) maturity scoring implementation described herein generally assesses the degree of immersion an entity has in AI matters. An entity's degree of AI immersion provides useful insights into an entity that can be used, for instance, to identify marketing and sales opportunities, among other things.

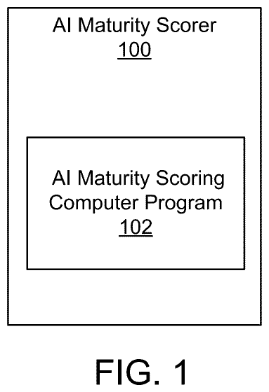

FIG. 1 illustrates one implementation, in simplified form, of a system framework for realizing the AI maturity scoring implementations described herein. As exemplified in FIG. 1, the system framework includes an AI maturity scorer 100 that includes one or more computing devices, and an AI maturity scoring computer program 102 having a plurality of sub-programs executable by the computing device or devices of the scorer.

In one implementation, the AI maturity score for an entity is a combination of three components, namely an AI component, a data science component, and a data maturity component. Each of these components will be described in more detail in the sections to follow.

### 1.1 AI Component

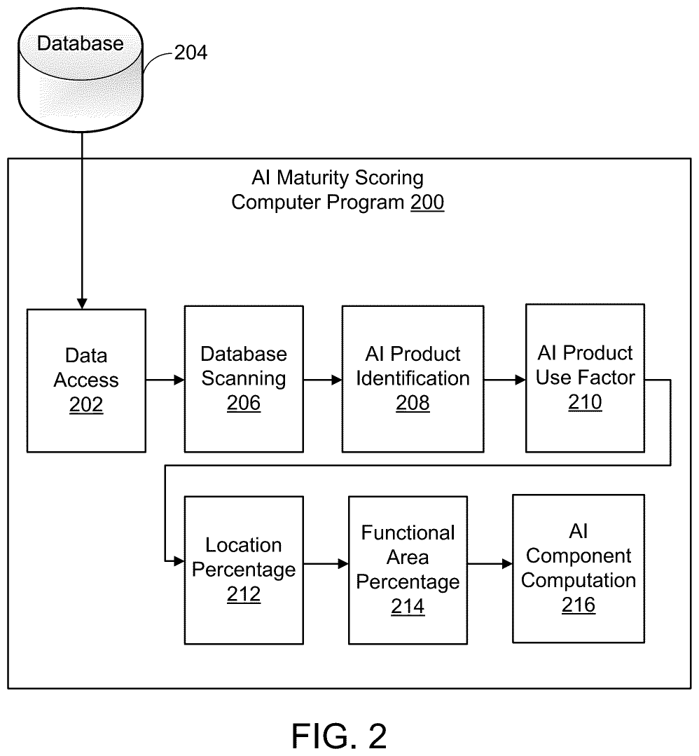

In general, the AI component quantifies the level of use of AI technologies at an entity. FIG. 2 illustrates one implementation, in simplified form, of the sub-programs included in the AI maturity scoring computer program 200 that configure the aforementioned computing device or devices to compute the AI component for entities of interest.

More particularly, a data access sub-program 202 is employed to receive input data from a database 204. In one implementation, the database includes a plurality of records (e.g., millions) that includes references to job titles, job descriptions, job locations, functional areas of an entity, dates, and entity information. The accessed data represents data collected over a prescribed period of time. For example, in one implementation the prescribed period of time is the previous 2-3 years. However, it is not intended that the AI maturity scoring implementations described herein be limited to this collection period. Rather, longer and shorter periods of time may be used depending on the quantity and accuracy of the data. In addition, the database records can be tagged with metadata that can include items such as the date the record was entered in the database or the date the information in the record was obtained, and so on. In one implementation, the source of the foregoing data can be any database that includes job data. For example, such data is available from LinkedIn Corporation, as well as various job resume and job listing databases. In addition, the database can include a combination of job profile data taken from more than one source. It is also noted that if the database records have not already been preprocessed for use in the procedures to be described in the sections to follow (e.g., formatted, disambiguated, and so on), this can be done using conventional methods for each record of the database prior to it being scanned.

In one implementation, a database scanning sub-program 206 is employed to scan the records of the database, including any metadata that is associated with a record, for software product names. The software product names can be identified using a product name identifier, such as described in “U.S. patent application Ser. No. 16/427,282, Published Dec. 3, 2020 (HG Insights Inc., applicant)”.

An AI product identification sub-program 208 is then employed to determine which of the software product names identified in the scan of the database are AI products using an AI product listing. The AI product listing is a listing of software products that have been previously identified as involving AI. It is noted that a version of an AI product listing is currently available from HG Insights Inc., Santa Barbara, CA. In addition, the AI product identification sub-program tags each database record containing a software product name found to match an AI product as an AI product-containing record.

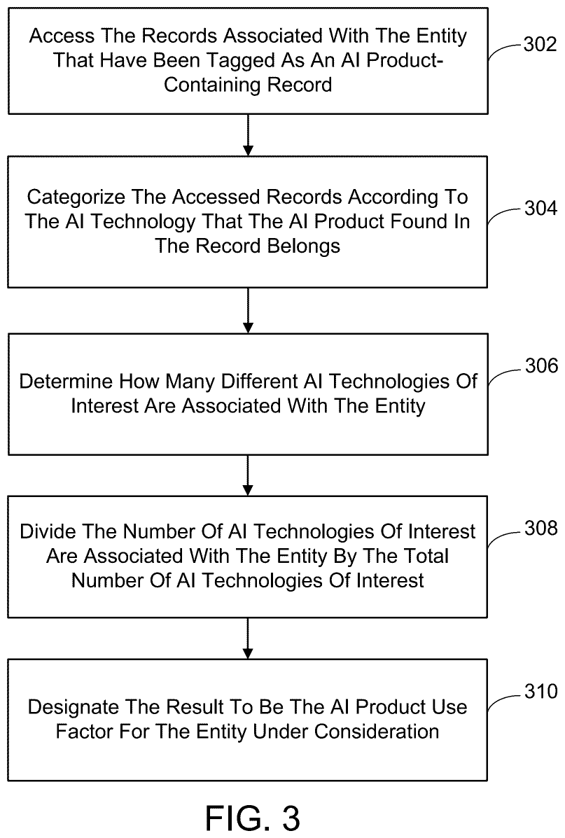

An AI product use factor sub-program 210 is then employed for each entity of interest to compute an AI product use factor for the entity. In general, the AI product use factor quantifies the use of AI products by the entity in terms of the AI technologies the AI products represent. In one implementation, the entity names are identified using an entity classifier, such as the entity classifiers described in “U.S. patent application Ser. No. 16/550,684, Published Mar. 4, 2021 (HG Insights Inc., applicant)”. It is noted that the entities of interest can be a selected group, or all of the entities found in the database. Referring to FIG. 3, in one implementation, the AI product use factor is computed by, for each entity of interest, first accessing the records associated with the entity that have been tagged as an AI product-containing record (302). The accessed records are then categorized according to the AI technology that the AI product found in the record belongs to using an AI technology listing (304). The AI technology listing is a listing of AI products and the AI technology they belong to. It is noted that a version of an AI technology listing is currently available from HG Insights Inc., Santa Barbara, CA. It is then determined how many different AI technologies of interest are associated with the entity (306) and this number is divided by the total number of AI technologies of interest (308). The AI technologies of interest can be a selected group, or all the AI technologies found in the AI technology listing. The result of the foregoing computation is then designated as the AI product use factor for the entity under consideration (310).

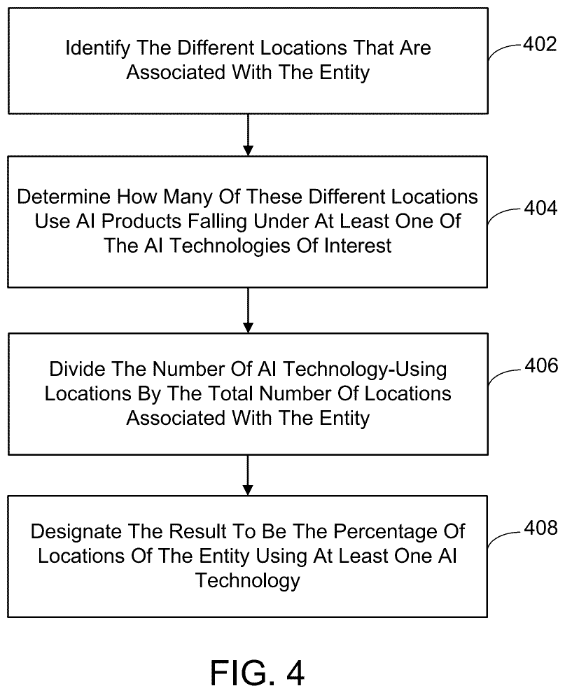

Next, referring again to FIG. 2, a location percentage sub-program 212 is employed to compute the percentage of locations of the entity under consideration which are using at least one AI technology. Referring to FIG. 4, in one implementation, the percentage of locations of the entity under consideration using at least one AI technology is computed by first identifying the different locations that are associated with the entity (402). In one implementation, the entity locations are identified using an entity location identifier, such as the entity location identifier described in “U.S. patent application Ser. No. 16/777,350, Published Aug. 5, 2021 (HG Insights Inc., applicant)”. It is then determined how many of these different locations use AI products falling under at least one of the AI technologies of interest (404) using the methods described previously. This number of AI technology-using locations is then divided by the total number of locations associated with the entity to produce the percentage of locations of the entity using at least one AI technology (406). The result of this calculation is then designated to be the percentage of locations of the entity using at least one AI technology (408).

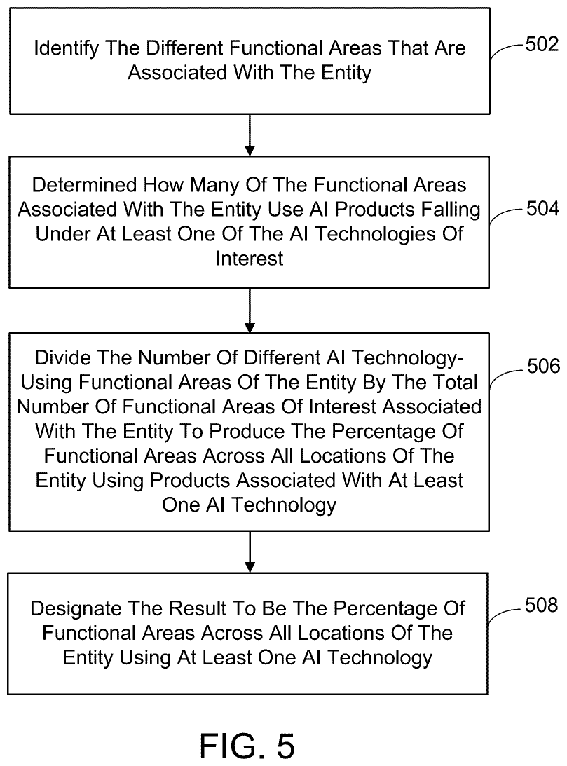

Additionally, a functional area percentage sub-program 214 is employed to compute the percentage of functional areas across all locations of the entity under consideration, which are using at least one AI technology. The functional area percentage represents the depth of AI spread and maturity across an entity. Thus, entities that have a higher functional area percentage may be more AI mature than entities having a lower functional area percentage. Referring to FIG. 5, in one implementation, the percentage of functional areas across all locations of the entity using products associated with at least one AI technology is computed by first identifying the different functional areas of interest that are associated with the entity (502). In one implementation, the functional areas of interest of an entity can be determined using a functional area classifier, such as the functional area classifier described in “U.S. patent application Ser. No. 17/193,992, Published Sep. 8, 2022 (HG Insights Inc., applicant)”. In a tested implementation, the functional area names deemed to be of interest in association with AI maturity scoring include Admin, Construction, Customer Success, Education, Engineering, Finance, HR, IT, Legal, Marketing, Medical, Operations, Product Management, Sales, and Science. It is then determined how many of these different functional areas use AI products falling under at least one of the AI technologies of interest (504) using the methods described previously. This number of different AI technology-using functional areas of the entity is then divided by the total number of different functional areas of interest associated with the entity (as previously identified by the aforementioned functional area classifier) to produce the percentage of functional areas across all locations of the entity using products associated with at least one AI technology (506). The result of this calculation is then designated as the percentage of functional areas across all locations of the entity using products associated with at least one AI technology (508).

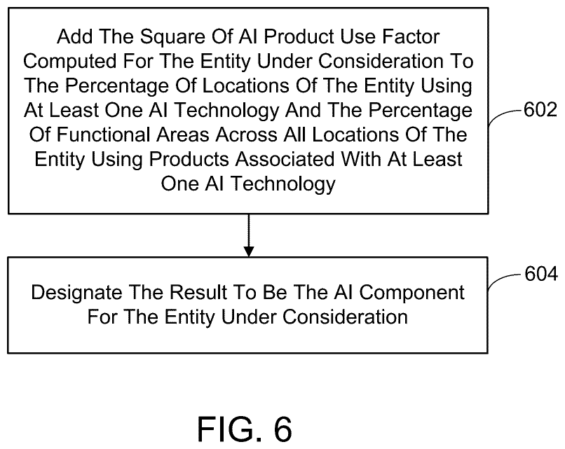

An AI component computation sub-program 216 is then employed to compute the AI component. Referring to FIG. 6, in one implementation, the AI component is computed by adding the square of AI product use factor computed for the entity under consideration to the percentage of locations of the entity using at least one AI technology and the percentage of functional areas across all locations of the entity using products associated with at least one AI technology (602). The result is then designated as the AI component for the entity under consideration (604).

### 1.2 Data Science Component

In general, the data science component is a number computed for each entity of interest that quantifies the level of an entity's data science expertise on a location basis. An entity's data science expertise is defined by identifying individuals associated with an entity that have data-oriented roles. For example, in a tested implementation, the data-oriented roles of interest included a data scientist, a data analyst, and a data engineer.

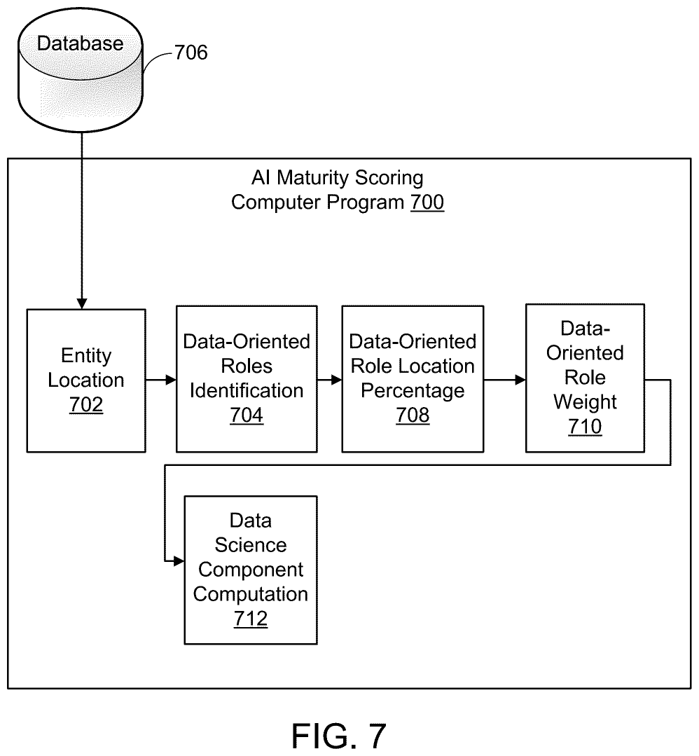

FIG. 7 illustrates one implementation, in simplified form, of the sub-programs included in the AI maturity scoring computer program 700 that configure the aforementioned computing device or devices to compute the data science component for each entity of interest. More particularly, an entity location sub-program 702 is employed to identify, for each entity of interest, the locations associated with the entity. The entity locations identified in computing the AI component can be reused here.

Next, a data-oriented roles identification sub-program 704 is employed to identify, for each entity and each of the entity's locations, the data-oriented roles of individuals working for the entity in that location. In one implementation, the data-oriented roles of individuals working for an entity at an entity's locations can be determined using a data-oriented role classifier. For example, as mentioned previously, in a tested implementation, three data-oriented roles were of interest—namely “data scientist”, “data analyst” and “data engineer”. It is noted that a version of a data-oriented role classifier is currently available from HG Insights Inc., Santa Barbara, CA. More particularly, the data-oriented roles of individuals working for an entity at an entity's locations are identified, for each of the entity's locations, by inputting each record from the database 706 associated with the entity's location into the classifier, and based on the content of the record (e.g., job titles and job descriptions) a data-oriented role of interest associated with the record, if any, is output.

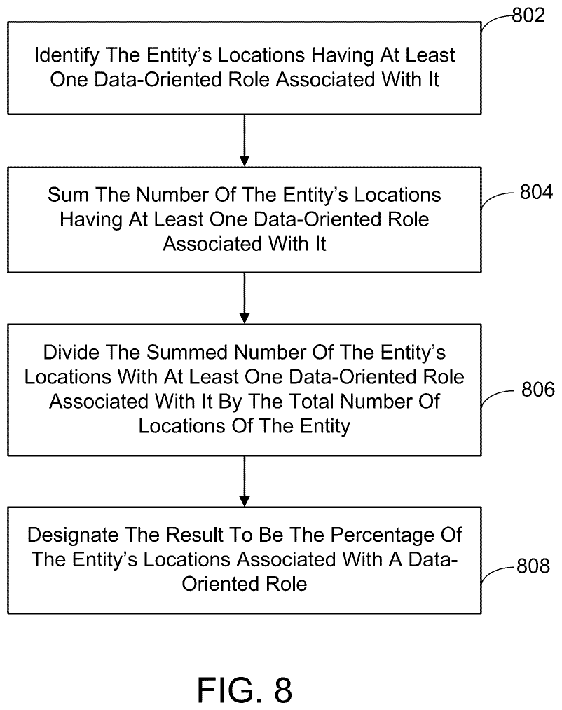

A data-oriented role location percentage sub-program 708 is then employed to find the percentage of each entity's locations that are associated with a data-oriented role. More particularly, referring to FIG. 8, in one implementation, the entity's locations having at least one data-oriented role associated with it are identified (802) and the total number of such locations is summed (804). The summed number of an entity's locations with at least one data-oriented role associated with it is then divided by the total number of locations that the entity has to produce a percentage of an entity's locations associated with a data-oriented role (806). The result of this calculation is then designated as the percentage of the entity's locations associated with a data-oriented role (808).

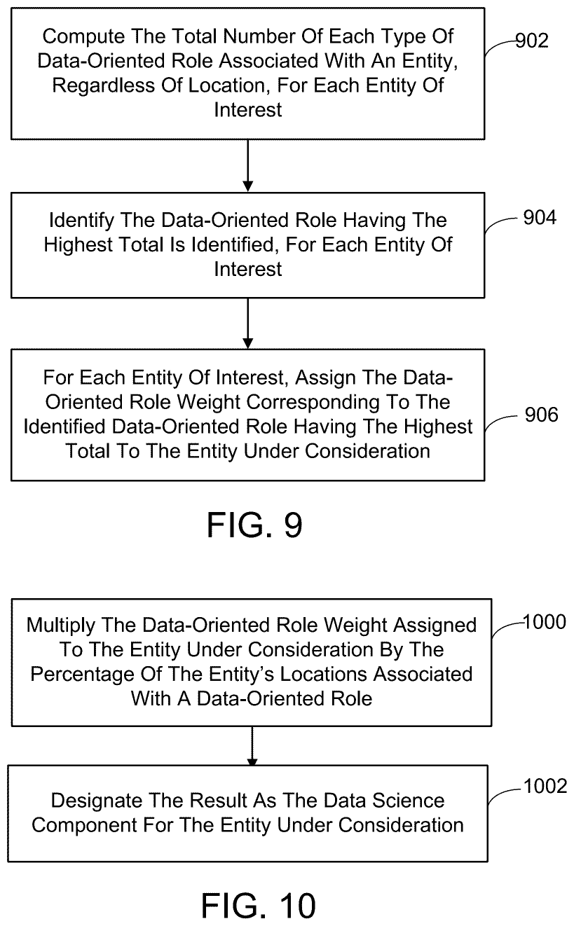

Referring again to FIG. 7, a data-oriented role weight sub-program 710 is employed next to compute a data science weight for each entity. The weight represents the relative degree of data science immersion of an entity. For example, in the aforementioned tested implementation, the data scientist role was assigned a weight of 1.0, the data analyst role was assigned a weight of 0.66 and the data engineer role was assigned a weight of 0.33. More particularly, referring to FIG. 9, in one implementation, for each entity of interest, the total number of each type of data-oriented role associated with the entity is computed, regardless of location (902). Next, the data-oriented role having the highest total is identified (904). This represents the entity's highest data science immersion role. Then, the data-oriented role weight corresponding to the identified data-oriented role having the highest total is assigned to the entity under consideration (906).

Referring once again to FIG. 7, a data science component computation sub-program 712 is employed to compute the data science component for each entity. More particularly, referring to FIG. 10, in one implementation, for each entity of interest, the data-oriented role weight assigned to the entity under consideration is multiplied by the percentage of the entity's locations associated with a data-oriented role (1002). The resulting number is designated as the data science component for the entity under consideration (1004).

### 1.3 Data Maturity Component

The data maturity of an entity refers to the degree to which the entity is involved in using data technologies. Quantifying the data maturity of an entity via a data maturity component is advantageous in the determination of an entity's overall AI maturity score because not all entities will be actively using AI in their business operations. However, if these entities have a high level of data maturity, it can be inferred that they are a prime candidate to adopt AI technologies owing to their already established data infrastructure. Thus, instead of quantifying the AI maturity of such entities with a low score or zero, adding in a data maturity component to the computation of the AI maturity score takes into consideration that an entity is AI ready.

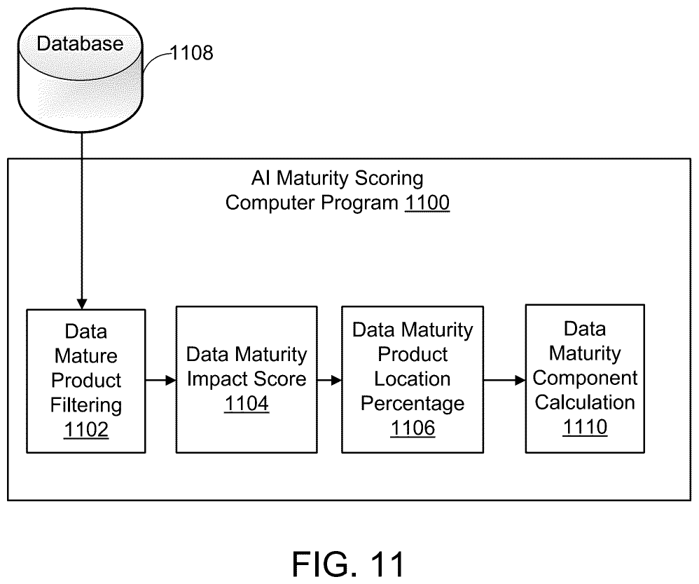

FIG. 11 illustrates one implementation, in simplified form, of the sub-programs included in the AI maturity scoring computer program 1100 that configure the aforementioned computing device or devices to compute the data maturity component for each entity of interest. More particularly, for each entity of interest, a data mature product filtering sub-program 1102 is employed to filter the previously discovered list of products in use by the entity under consideration to identify those products that are also found in a data mature products listing. The listing of data mature products includes the names of products considered to be data mature products and also includes a weight associated with each data mature product indicative of the level of pervasiveness of the product among entities deemed to be data mature. For example, products associated with data warehousing, data management and storage, and IT infrastructure can be considered data mature products. It is noted that a version of a data mature products listing is currently available from HG Insights Inc., Santa Barbara, CA. This list was generated in part by finding the products being used by the top 1000 entities deemed to be data mature based on their AI component and data science component scores.

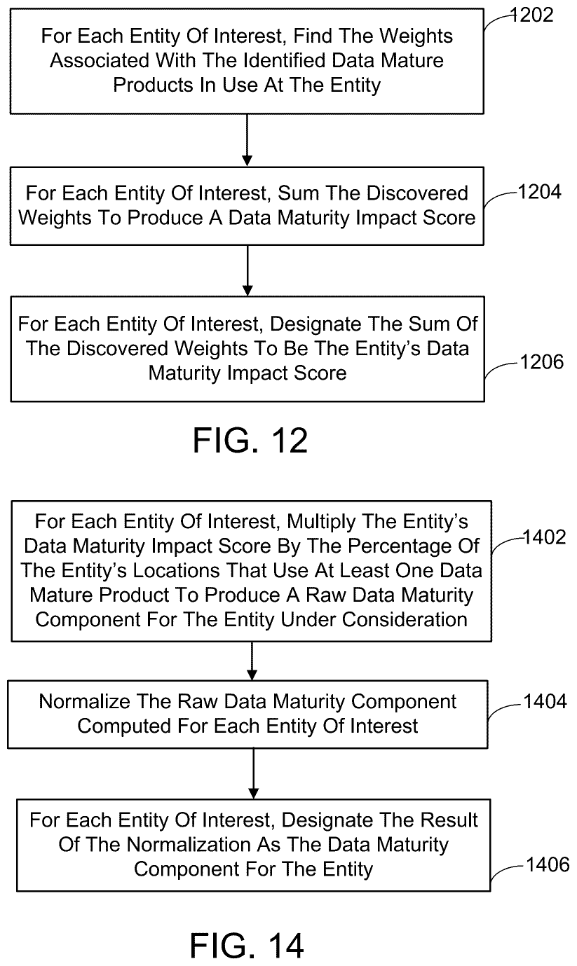

For each entity of interest, a data maturity impact score sub-program 1104 is then employed. More particularly, referring to FIG. 12, in one implementation, for each entity of interest, the weights associated with the identified data mature products in use at the entity are found in the data mature products listing (1202). The discovered weights are then summed to produce a data maturity impact score for the entity under consideration (1204). This sum is designated as the data maturity impact score for the entity under consideration (1206).

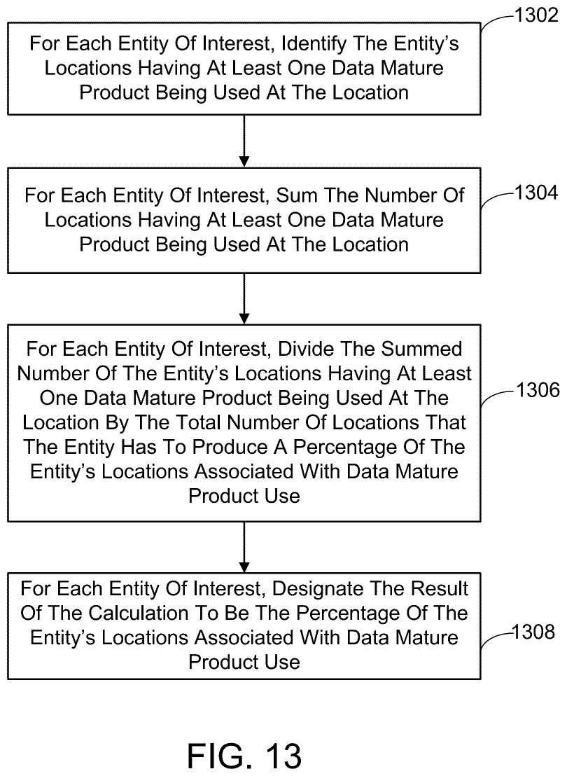

Additionally, referring again to FIG. 11, for each entity of interest, a data maturity product location percentage sub-program 1106 is employed to compute the percentage of the entity's locations (as identified previously using the database 1108) that use at least one data mature product. More particularly, referring to FIG. 13, in one implementation, for each entity of interest, the entity's locations having at least one data mature product being used at the location are identified (1302) and the total number of such locations is summed (1304). The summed number of the entity's locations having at least one data mature product being used at the location is then divided by the total number of locations that the entity has to produce a percentage of the entity's locations associated with data mature product use (1306). The result is then designated as the percentage of the entity's locations associated with data mature product use for the entity under consideration (1308). It is noted that using the percentage of the entity's locations that use at least one data mature product as a factor in computing the data maturity score for the entity recognizes situations where only some of the entity's locations are “data mature” and so the entity should not be scored as highly as an entity where more or all of its locations are data mature.

Finally, referring again to FIG. 11, for each entity of interest, a data maturity component calculation sub-program 1110 is employed to compute the data maturity component for the entity under consideration. More particularly, referring to FIG. 14, in one implementation, for each entity of interest, the data maturity component is calculated by multiplying the entity's data maturity impact score by the percentage of the entity's locations that use at least one data mature product to produce a raw data maturity component for the entity under consideration (1402). The raw data maturity component computed for each entity of interest is then normalized in view of the raw data maturity components computed for all the entities of interest (1404). For each entity of interest, the result of the normalization is designated as the data maturity component for the entity (1406). It is noted that the normalization is performed so that the data maturity component computed for an entity can be combined with the previously described AI component and data science component to calculate the overall AI maturity score.

### 1.4 The AI Maturity Score

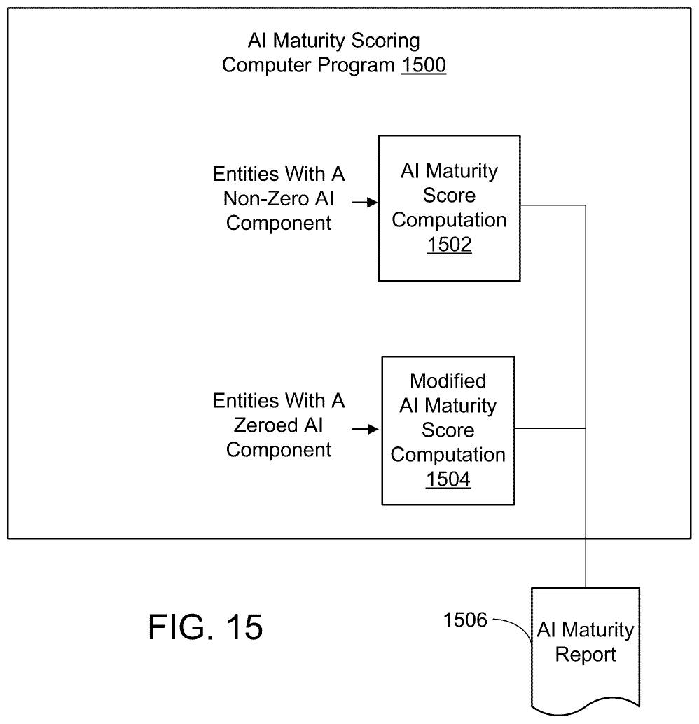

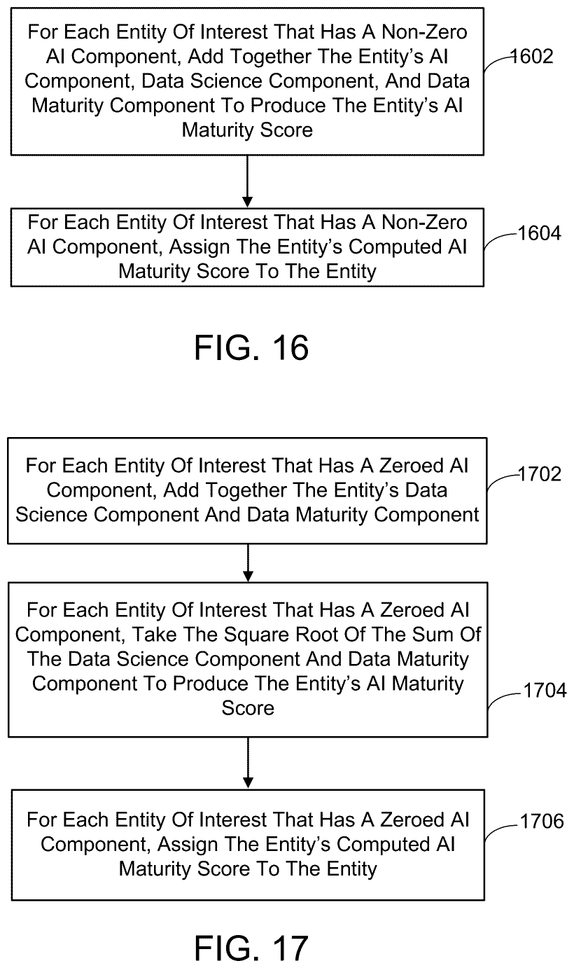

The AI maturity score is then computed for each entity under consideration. The AI maturity score is an indicator of how prevalent AI technology and AI products are in an entity. FIG. 15 illustrates one implementation, in simplified form, of the sub-programs included in the AI maturity scoring computer program 1500 that configures the aforementioned computing device or devices to compute the AI maturity score for each entity of interest. More particularly, for each entity of interest that has a non-zero AI component, an AI maturity score computation sub-program 1502 is employed to compute the AI maturity score for the entity. Referring to FIG. 16, in one implementation, for each entity of interest that has a non-zero AI component, the AI maturity score is computed by adding together the AI component, the data science component, and the data maturity component (1602). The computed AI maturity score is then assigned to the entity under consideration (1604).

However, referring again to FIG. 15, in cases where there is no AI product in use by an entity (i.e., the AI component is zero), the AI maturity score for that company is penalized to reflect this non-use but still provide a score that recognizes the AI readiness of such an entity. More particularly, for each entity of interest that has a zeroed AI component, a modified AI maturity score computation sub-program 1504 is employed to compute the AI maturity score for the entity. Referring to FIG. 17, in one implementation, for each entity of interest that has a zeroed AI component, the AI maturity score is computed by adding together the data science component and data maturity component of the entity under consideration (1702). The square root of the sum of the data science component and data maturity component is then computed to produce the AI maturity score for the entity (1704). The computed AI maturity score is then assigned to the entity under consideration (1706). Referring again to FIG. 15, the AI maturity score computed for each of the entities of interest is included in an AI maturity scoring report 1506, which will be described in more detail in the sections to follow.

### 1.4.1 Ranking

The AI maturity score has many advantageous uses. For example, an AI maturity report can be generated that ranks entities by their AI maturity score. This report can be used to identify marketing and sales opportunities, among other things. For example, an entity that ranks higher in the list could be a potential customer for AI related products. In one implementation, the entities of interest are ranked by first normalizing the AI maturity scores. A ranking number (e.g., 1, 2, 3 . . . ) is then assigned to each entity of interest based on the normalized scores. The lower the rank number for an entity, the higher the rank. The rank of an entity indicates the degree to which the entity is immersed in AI matters compared to the other entities.

### 1.4.2 AI Maturity Score Changes Over Time

Another advantageous use of the AI maturity scores involves looking at how an entity's score changes over time. For example, in an implementation such as described previously where the database records and their associated metadata include items such as the date the record was entered in the database or the date the information in the record was obtained, and so on, these dates can be used to establish a “date for the record”. For example, the date for the record could reflect the latest date the information in the record was believed to be valid. Characterizing the database records by their “record date” allows the records to be organized into a timeline. The foregoing AI maturity scoring implementations can then be applied to subsets of the timeline to establish an AI maturity score for an entity for a particular time period. For example, the database records can be divided into 6-month intervals, and the AI maturity score for the entities of interest can be computed for each of the intervals. This allows consecutive AI scores to be analyzed and characterized by the change in the score over time. Once AI maturity scores have been computed for consecutive time periods, trends can be identified. For example, if the AI maturity for an entity is trending upward over time, that entity might be a potential customer for AI related products even if their AI maturity score is not as high as other entities.

Further, the change in AI maturity scores over time can be analyzed over all entities or over a segment of the entities. For example, if the AI maturity scores are increasing on average over all the entities, this might indicate the environment is ripe for the development of new AI products. Even if the overall average maturity score is not increasing, it might be for a segment of the entities. For example, if the entities belonging to a particular technology sector, or the entities located in a particular region have average AI maturity scores that are increasing, this could indicate that potential customers for AI related products might exist in the segment of entities having an increasing AI maturity score. Similarly, the increase in AI maturity scores over time in a particular segment could indicate a need for the development of new AI products tailored to the needs of that segment.

### 1.4.3 AI Maturity Scoring Report

Referring once again to FIG. 15, the AI maturity scoring computer program 1500 further includes a report generation sub-program 1506. In general, the report generation sub-program 1506 generates an AI maturity scoring report 1508. The AI maturity scoring report can be quite simple and just list, for each of the entities of interest, its AI maturity score. In other implementations of the AI maturity scoring report, in addition to the AI maturity score for each entity of interest, the report could also include a ranking of the entities of interest based on their current AI maturity score, and/or one or more AI maturity scores from previous time periods. It may also be beneficial to include the various elements that went into computing the AI maturity score of each entity of interest.

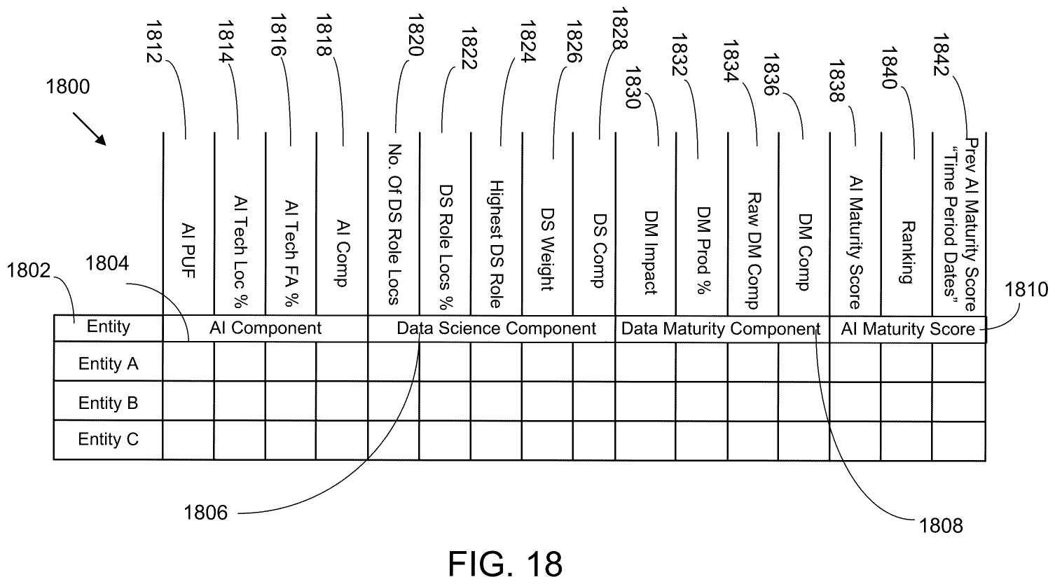

Referring to FIG. 18, an implementation that includes many of the elements that go into computing the AI maturity score, as well as a ranking and past AI maturity scores, is shown. It is noted that the AI maturity scoring report shown in FIG. 18 is only an example. Reports that include more information, or less, can also be generated. For example, while not shown in the AI maturity scoring report of FIG. 18, additional information about an entity of interest can be included, such as its URL, locations, location count, industry type, size (e.g., revenue, employee count), and so on. It is also noted that while the exemplary AI maturity scoring report shown in FIG. 18 is in the form of a table, this format is not the only format the report can take. In the exemplary AI maturity scoring report 1800 shown in FIG. 18, the entities of interest 1802 are listed in the first column. Three such entities (Entity A, Entity B, Entity C) are shown for convenience but there could be more or less. The remaining columns list the various elements that go into computing the AI maturity score, as well as a past AI maturity score and a current ranking. It is noted that the cells where values would be seen have been left blank but in an actual report these cells would be filled in. The elements are organized into higher level groups, namely AI component elements 1804, data science elements 1806, data maturity elements 1808, and AI maturity score elements 1810. The AI component elements 1804 include the AI product use factor (AI PUF) 1812, percentage of locations using AI technology (AI Tech Loc %) 1814, percentage of functional areas using AI technology (AI Tech FA %) 1816, and the AI component (AI Comp) 1818. The data science elements 1806 include the number of locations having at least one individual with a data-oriented role (No. Of DS Role Locs) 1820, percentage of locations having at least one individual with a data-oriented role (DS Role Locs %) 1822, data-oriented role having the highest number of individuals (Highest DS Role) 1824, data-oriented role weight associated with the highest data-oriented role (DS Weight) 1826, and the data science component (DS Comp) 1828. The data maturity elements 1808 include the data maturity impact score (DM Impact) 1830, percentage of locations using at least one data mature product (DM Prod %) 1832, raw data maturity component (Raw DM Comp) 1834, and the normalized data maturity component (DM Comp) 1836. The AI maturity score elements 1810 include the current AI maturity score (AI Maturity Score) 1838, ranking based on the current AI maturity score (Ranking) 1840, and at least one AI maturity score from a previous time period (Prev AI Maturity Score—“Time Period Dates”) 1842. It is noted that one previous AI maturity score is shown in FIG. 18, but there could be earlier ones as well.

### 1.5 AI Maturity Scoring Process

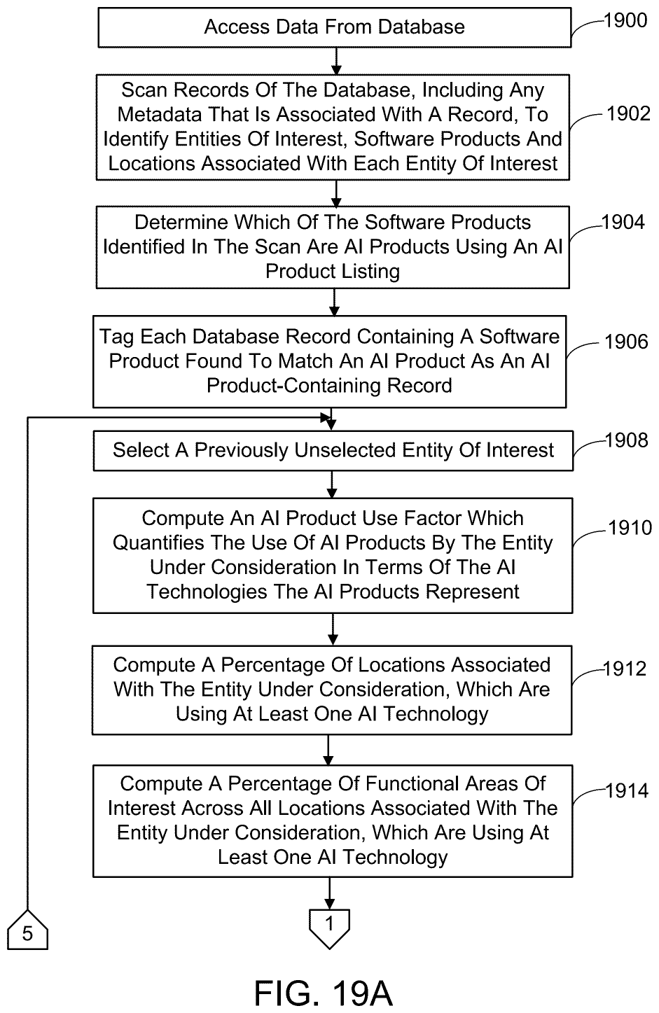

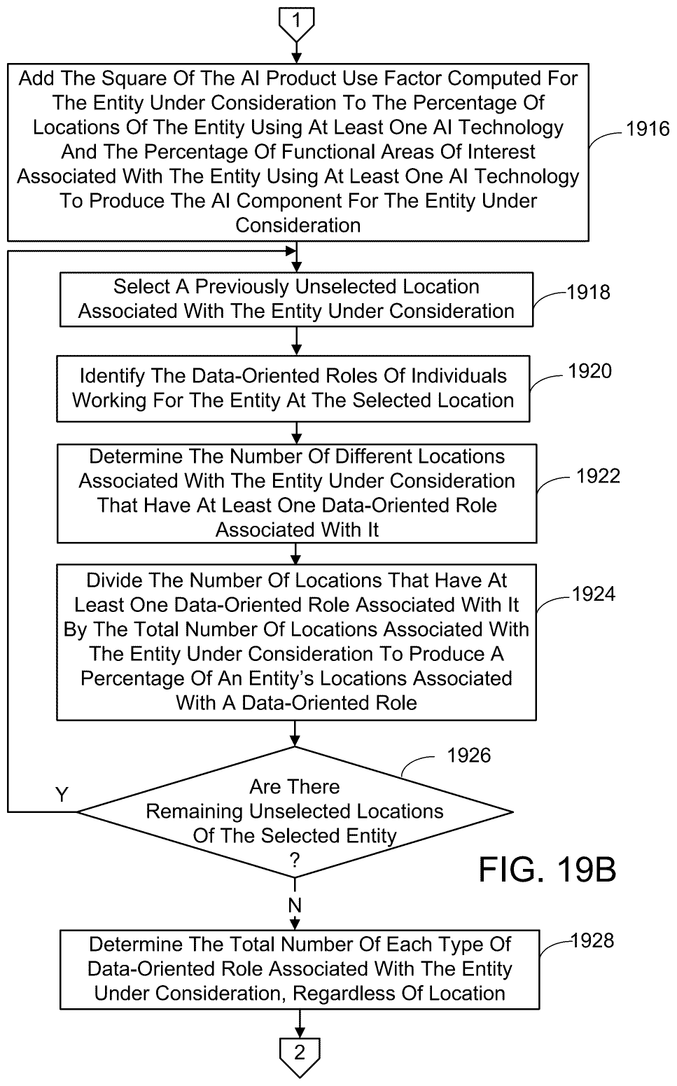

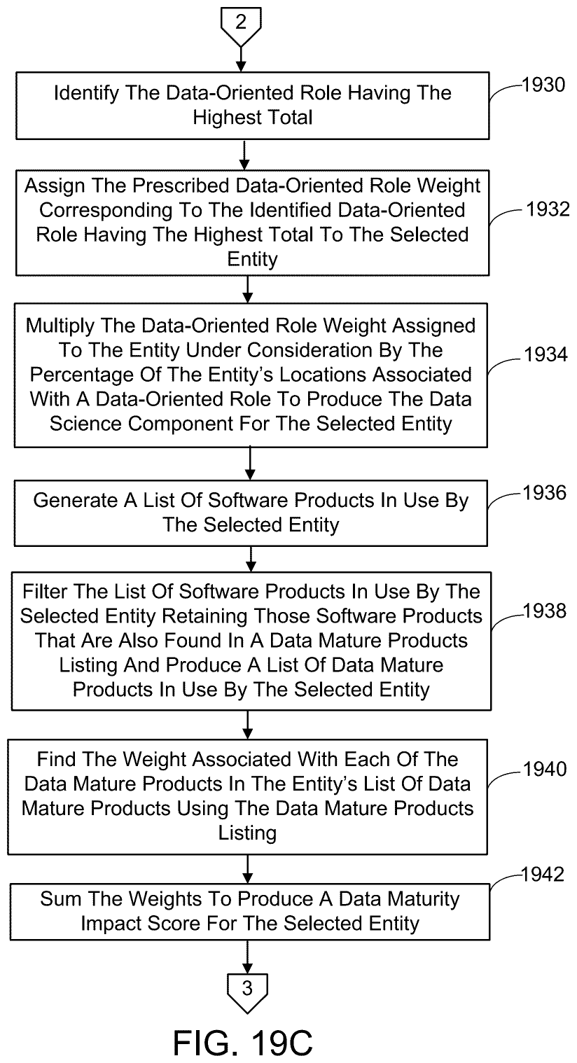

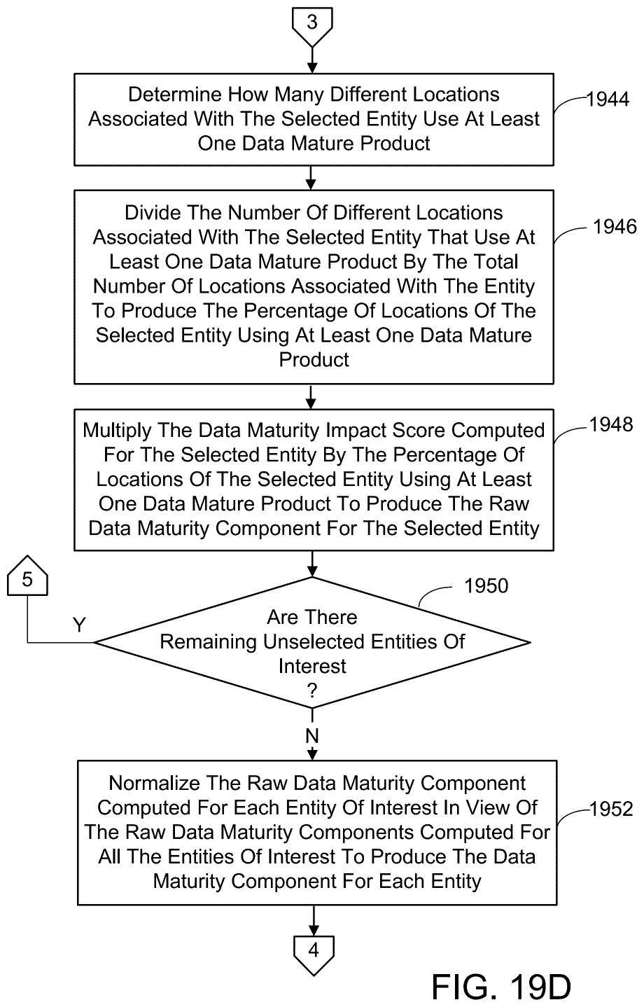

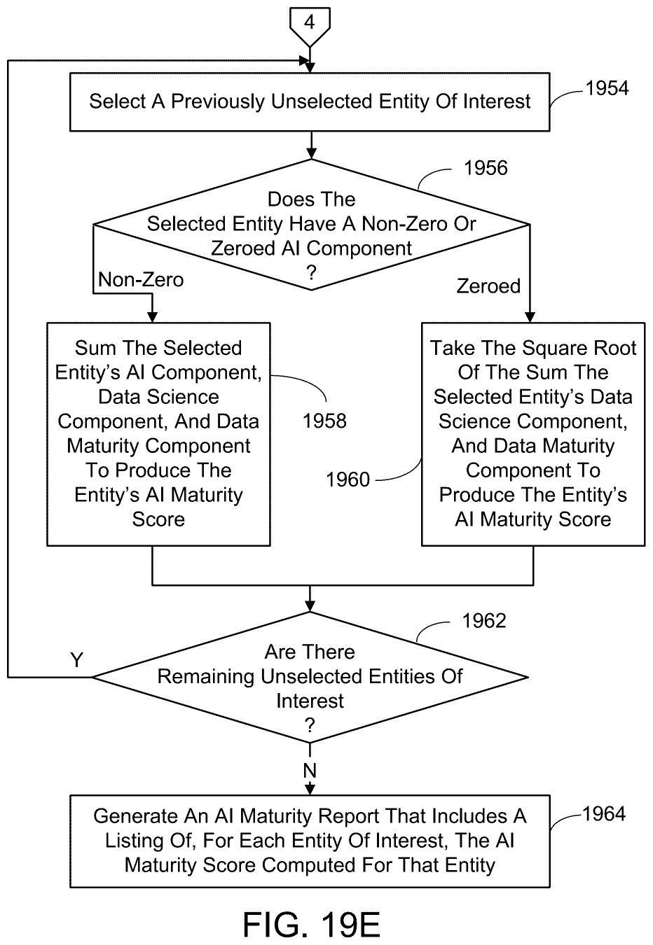

FIGS. 19A-E illustrate an exemplary process for scoring the AI maturity of entities, which in one implementation of the AI maturity scoring described herein is realized using the system framework illustrated in FIG. 1. More particularly, the process uses one or more computing devices to perform the following process actions. The computing devices are in communication with each other via a computer network whenever a plurality of computing devices is used. As exemplified in FIGS. 19A-E, the process starts with accessing data from a database (1900). As described previously, the database includes a plurality of records with data including job titles, job descriptions, job locations, functional areas of an entity, dates, and entity information. The records of the database, including any metadata that is associated with a record, are scanned to identify entities of interest, software products and to identify locations associated with each entity of interest (1902). It is then determined which of the software products identified in the scan are AI products using an AI product listing (1904). As described previously, the AI product listing includes a listing of software products that have been previously identified as involving AI. Each database record containing a software product found to match an AI product is tagged as an AI product-containing record (1906).

Next, a previously unselected entity of interest found in the database records is selected (1908), and an AI component that quantifies the level of use of AI technologies at the entity under consideration (i.e., the selected entity) is computed. In one implementation, computing the AI component includes computing an AI product use factor which quantifies the use of AI products by the entity under consideration in terms of the AI technologies the AI products represent (1910), computing a percentage of locations associated with the entity under consideration, which are using at least one AI technology (1912), computing a percentage of functional areas of interest across all locations associated with the entity under consideration, which are using at least one AI technology (1914), and adding the square of the AI product use factor computed for the entity under consideration to the percentage of locations of the entity using at least one AI technology and the percentage of functional areas of interest associated with the entity using at least one AI technology to produce the AI component for the entity under consideration (1916).

A data science component that quantifies the level of an entity's data science expertise on a location basis is then computed for the entity under consideration. In one implementation, computing the data science component includes first selecting a previously unselected location associated with the entity under consideration (1918). The data-oriented roles of individuals working for the entity at that location are then identified (1920) and the number of different locations associated with the entity under consideration having at least one data-oriented role associated with it is determined (1922). The number of locations that have at least one data-oriented role associated with it is then divided by the total number of locations associated with the entity under consideration to produce a percentage of an entity's locations associated with a data-oriented role (1924). Next, it is determined if there are remaining unselected locations associated with the entity under consideration (1926). If there are remaining unselected locations, then the process repeats starting with action 1918. However, if there are no remaining unselected locations associated with the entity under consideration, then the total number of each type of data-oriented role associated with the entity under consideration is determined, regardless of location (1928), and the data-oriented role having the highest total is identified (1930). Next, a prescribed data-oriented role weight corresponding to the identified data-oriented role having the highest total is assigned to the entity under consideration (1932). The data-oriented role weight assigned to the entity under consideration is multiplied by the percentage of the entity's locations associated with a data-oriented role to produce the data science component for the entity under consideration (1934).

A raw data maturity component that quantifies the degree to which the entity under consideration is involved in using data technologies is computed next. In one implementation, computing the raw data maturity component includes first generating a list of software products in use by the entity under consideration (1936) and then filtering the list of software products in use by the entity under consideration to retain those software products that are also found in a data mature products listing and so produce a list of data mature products in use by the entity under consideration (1938). As described previously, the data mature products list includes the names of software products considered to be data mature products and a weight associated with each data mature product indicative of the level of pervasiveness of the product among entities deemed to be data mature. The weight associated with each of the data mature products in the entity's list of data mature products is found using the data mature products listing (1940) and the weights are summed to produce a data maturity impact score for the entity under consideration (1942). It is next determined how many different locations associated with the entity under consideration use at least one data mature product (1944), and this number of different locations associated with the entity under consideration that use at least one data mature product is divided by the total number of locations associated with the entity to produce the percentage of locations of the entity under consideration using at least one data mature product (1946). The data maturity impact score computed for the entity under consideration is then multiplied by the percentage of locations of the entity under consideration using at least one data mature product to produce the raw data maturity component for the entity under consideration (1948). Next, it is determined if there are remaining unselected entities of interest (1950). If there are remaining unselected entities of interest, then the process repeats starting with action 1908. However, if there are no remaining unselected entities of interest, then the raw data maturity component computed for each entity of interest is normalized in view of the raw data maturity components computed for all the entities of interest to produce the data maturity component for each entity (1952).

The AI maturity score is then computed for each of the entities of interest. This involves once again selecting each of the entities of interest in turn. More particularly, a previously unselected entity of interest is selected (1954), and it is determined if the entity under consideration has a non-zero or zeroed AI component (1956). If the entity under consideration has a non-zero AI component, then the entity's AI maturity score is computed by summing the AI component, the data science component, and the data maturity component previously computed for the entity (1958). However, if the entity under consideration has a zeroed AI component, then the entity's AI maturity score is computed by summing the data science component and the data maturity component previously computed for the entity under consideration and taking the square root of the sum (1960). Next, it is determined if there are remaining unselected entities of interest (1962). If there are remaining unselected entities of interest, then the process repeats starting with action 1954. However, if there are no remaining unselected entities of interest, then an AI maturity report is generated that includes a listing of, for each entity of interest, the AI maturity score computed for that entity (1964).

### 2.0 Other Implementations

While AI maturity scoring techniques have been described by specific reference to implementations thereof, it is understood that variations and modifications thereof can be made without departing from the true spirit and scope.

It is further noted that any or all of the implementations that are described in the present document and any or all of the implementations that are illustrated in the accompanying drawings may be used and thus claimed in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 3.0 Exemplary Operating Environments

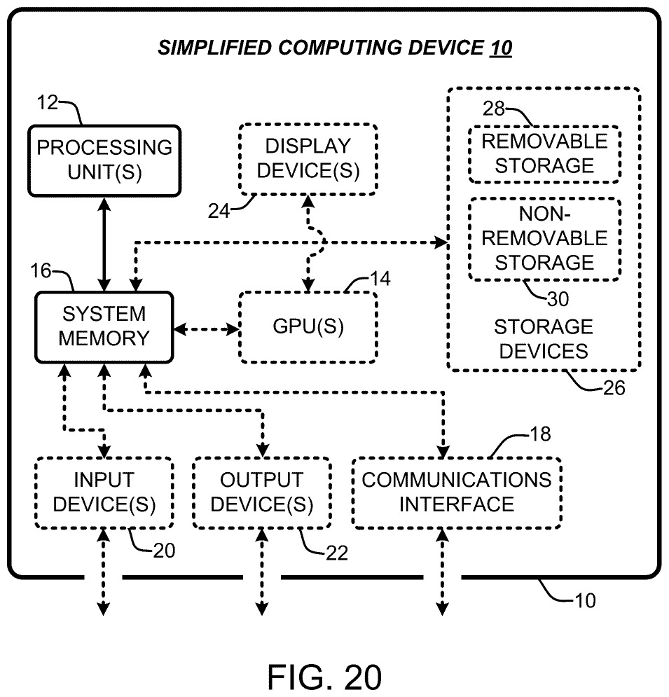

The AI maturity scoring implementations described herein are operational within numerous types of general purpose or special purpose computing system environments or configurations. FIG. 20 illustrates a simplified example of a general-purpose computer system on which various implementations and elements of the AI maturity scoring, as described herein, may be implemented. It is noted that any boxes that are represented by broken or dashed lines in the simplified computing device 10 shown in FIG. 20 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the AI maturity scoring implementations described herein, the device should have a sufficient computational capability and system memory to enable basic computational operations. In particular, the computational capability of the simplified computing device 10 shown in FIG. 20 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the AI maturity scoring implementations described herein, including input, output, control, feedback, and response to one or more users or other devices or systems associated with the AI maturity scoring implementations, are enabled by a variety of Natural User Interface (NUI) scenarios. The NUI techniques and scenarios enabled by the AI maturity scoring implementations include, but are not limited to, interface technologies that allow one or more users to interact with the AI maturity scoring implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the AI maturity scoring implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the AI maturity scoring implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 20 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various AI maturity scoring implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The AI maturity scoring implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The AI maturity scoring implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor. Still further, the AI maturity scoring implementations described herein can be virtualized and realized as a virtual machine running on a computing device such as any of those described previously. In addition, multiple AI maturity scoring virtual machines can operate independently on the same computer device.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

Wherefore, what is claimed is:

1. A system for scoring artificial intelligence (AI) maturity of an entity, comprising:
an AI maturity scorer comprising one or more computing devices, and an AI maturity scoring computer program having a plurality of sub-programs executable by said computing device or devices, wherein the sub-programs configure said computing device or devices to,
access data from a database, said database comprising a plurality of records comprising data including job titles, job descriptions, job locations, functional areas of an entity, dates, and entity information,
scan the records of the database, including any metadata that is associated with a record, to identify entities of interest,
for each entity of interest,
compute an AI component that quantifies the level of use of AI technologies at the entity under consideration,
compute a data science component that quantifies the level of an entity's data science expertise on a location basis,
compute a data maturity component that quantifies the degree to which the entity is involved in using data technologies, and
compute an AI maturity score based on the AI component, data science component, and data maturity component, and
generate an AI maturity report comprising a listing of, for each entity of interest, the AI maturity score computed for that entity.

2. The AI maturity scoring system of claim 1, wherein one or more of the sub-programs for computing the AI component, data science component, and data maturity component, comprises sub-programs which configure said computing device or devices to:
scan the records of the database, including any metadata that is associated with a record, to identify software products;
determine which of the software products identified in the scan are AI products using an AI product listing, said AI product listing comprising a listing of software products that have been previously identified as involving AI; and
tag each database record containing a software product found to match an AI product as an AI product-containing record.

3. The AI maturity scoring system of claim 2, wherein the sub-program for computing the AI component comprises sub-programs which configure said computing device or devices to:
for each entity of interest,
compute an AI product use factor which quantifies the use of AI products by the entity under consideration in terms of the AI technologies the AI products represent,
compute a percentage of locations associated with the entity under consideration, which are using at least one AI technology,
compute a percentage of functional areas of interest across all locations associated with the entity under consideration, which are using at least one AI technology, and
compute the AI component for the entity under consideration, said AI component computation comprising adding the square of the AI product use factor computed for the entity under consideration to the percentage of locations of the entity using at least one AI technology and the percentage of functional areas of interest associated with the entity using at least one AI technology to produce the AI component for the entity under consideration.

4. The AI maturity scoring system of claim 3, wherein the functional areas of interest comprise administration, construction, customer success, education, engineering, finance, human resources (HR), information technology (IT), legal, marketing, medical, operations, product management, sales, and science.

5. The AI maturity scoring system of claim 3, wherein the sub-program for computing the AI product use factor comprises sub-programs which configure said computing device or devices to:
access all the records associated with the entity under consideration that have been tagged as an AI product-containing record;
categorize the accessed AI product-containing records according to the AI technology that the AI product found in the record belongs to using an AI technology listing, said AI technology listing comprising a listing of AI products and the AI technology the AI product belongs to; and
determine how many different AI technologies of interest are associated with the entity under consideration and divide the number of AI technologies of interest associated with the entity by the total number of AI technologies of interest to produce an AI product use factor for the entity under consideration.

6. The AI maturity scoring system of claim 3, wherein the sub-program for computing the percentage of locations associated with the entity under consideration which are using at least one AI technology, comprises sub-programs which configure said computing device or devices to:
scan the records of the database, including any metadata that is associated with a record, to identify locations associated with the entity under consideration; and
determine how many different locations associated with the entity under consideration use at least one AI product that corresponds to one of the AI technologies of interest and dividing the determined number of different locations by the total number of locations associated with the entity to produce the percentage of locations of the entity under consideration using at least one AI technology.

7. The AI maturity scoring system of claim 3, wherein the sub-program for computing the percentage of functional areas across all locations associated with the entity under consideration, which are using at least one AI technology, comprises sub-programs which configure said computing device or devices to:
scan the records of the database, including any metadata that is associated with a record, to identify functional areas of interest associated with the entity under consideration; and
determine how many different functional areas of interest associated with the entity under consideration use at least one AI product that corresponds to one of the AI technologies of interest and divide the number of functional areas of interest associated with the entity under consideration that use at least one AI product that corresponds to one of the AI technologies by the total number of functional areas of interest associated with the entity to produce the percentage of functional areas of interest associated with the entity using at least one AI technology.

8. The AI maturity scoring system of claim 2, wherein the sub-program for computing the data science component comprises sub-programs which configure said computing device or devices to:
for each entity of interest,
scan the records of the database, including any metadata that is associated with a record, to identify locations associated with the entity under consideration,
for each of the identified locations associated with the entity under consideration,
identify the data-oriented roles of individuals working for the entity at that location,
determine how many different locations associated with the entity under consideration have at least one data-oriented role associated with it, and
divide the number of locations that have at least one data-oriented role associated with it by the total number of locations associated with the entity to produce a percentage of an entity's locations associated with a data-oriented role,
determine the total number of each type of data-oriented role associated with the entity under consideration, regardless of location, and identify the data-oriented role having the highest total,
assign a prescribed data-oriented role weight corresponding to the identified data-oriented role having the highest total to the entity under consideration, and
multiply the data-oriented role weight assigned to the entity under consideration by the percentage of the entity's locations associated with a data-oriented role to produce the data science component for the entity under consideration.

9. The AI maturity scoring system of claim 8, wherein the data-oriented roles comprise a data scientist, a data analyst, and a data engineer.

10. The AI maturity scoring system of claim 9, and wherein the prescribed data-oriented role weight for a data scientist is 1.0, the prescribed data-oriented role weight for a data analyst is 0.66, and the prescribed data-oriented role weight for a data engineer is 0.33.

11. The AI maturity scoring system of claim 2, wherein the sub-program for computing the data maturity component comprises sub-programs which configure said computing device or devices to:
for each entity of interest,
generate a list of software products in use by the entity under consideration,
filter the list of software products in use by the entity under consideration to retain those software products that are also found in a data mature products listing that lists the names of software products considered to be data mature products and a weight associated with each data mature product indicative of the level of pervasiveness of the product among entities deemed to be data mature, to produce a list of data mature products in use by the entity under consideration,
find the weight associated with each of the data mature products in the list of data mature products using the data mature products listing and sum the discovered weights to produce a data maturity impact score for the entity under consideration,
scan the records of the database, including any metadata that is associated with a record, to identify locations associated with the entity under consideration,
determine how many different locations associated with the entity under consideration use at least one data mature product and divide the number of different locations associated with the entity under consideration that use at least one data mature product by the total number of locations associated with the entity to produce the percentage of locations of the entity under consideration using at least one data mature product, and
multiply the data maturity impact score computed for the entity under consideration by the percentage of locations of the entity under consideration using at least one data mature product to produce a raw data maturity component for the entity under consideration; and
for each entity of interest, normalize the raw data maturity component computed for entity under consideration in view of the raw data maturity components computed for all the entities of interest to produce the data maturity component for the entity under consideration.

12. The AI maturity scoring system of claim 11, wherein software products considered to be data mature products comprise software products associated with data warehousing, data management and storage, and information technology (IT) infrastructure.

13. The AI maturity scoring system of claim 1, wherein the sub-program for computing the AI maturity score based on the AI component, data science component, and data maturity component comprises a sub-program which configures said computing device or devices to, for each entity of interest that has a non-zero AI component, sum the AI component, the data science component, and the data maturity component computed for the entity under consideration to produce the AI maturity score for the entity under consideration.

14. The AI maturity scoring system of claim 1, wherein the sub-program for computing the AI maturity score based on the AI component, data science component, and data maturity component comprises a sub-program which configures said computing device or devices to, for each entity of interest that has a zeroed AI component, sum the data science component and the data maturity component computed for the entity under consideration and take the square root of the sum to produce an AI maturity score for the entity under consideration.

15. The AI maturity scoring system of claim 1, wherein the sub-program for generating the AI maturity report further comprises including a ranking number for each entity of interest, wherein the ranking number for each entity of interest indicates how high that entity's AI maturity score is in comparison to the AI maturity scores of all the entities of interest.

16. A system for scoring artificial intelligence (AI) maturity of an entity, comprising:
an AI maturity scorer comprising one or more computing devices, and an AI maturity scoring computer program having a plurality of sub-programs executable by said computing device or devices, wherein the sub-programs configure said computing device or devices to,
access data from a database, said database comprising a plurality of records comprising data including job titles, job descriptions, job locations, functional areas of an entity, dates, and entity information,
scan the records of the database, including any metadata that is associated with a record, to identify for each record, a date representing the latest date information in the record is likely to be valid and assign the identified data as the date of the record,
divide the database records into groups based on which period of time the assigned date of the record falls, wherein the periods of time are sequential, each cover a prescribed-length period of time, and comprise a current time period and one or more previous time periods,
scan the records of the database, including any metadata that is associated with a record, to identify entities of interest,
for each entity of interest and for each time period,
compute an AI component that quantifies the level of use of AI technologies at the entity under consideration,
compute a data science component that quantifies the level of an entity's data science expertise on a location basis,
compute a data maturity component that quantifies the degree to which the entity is involved in using data technologies, and
compute an AI maturity score based on the AI component, data science component, and data maturity component, and generate an AI maturity report comprising a separate listing of, for each entity of interest, the AI maturity score computed for that entity for each time period.

17. The AI maturity scoring system of claim 16, wherein each time period is 6 months in length.

18. A computer-implemented process for scoring artificial intelligence (AI) maturity of an entity, the process comprising the actions of:
using one or more computing devices to perform the following process actions, the computing devices being in communication with each other via a computer network whenever a plurality of computing devices is used:
accessing data from a database, said database comprising a plurality of records comprising data including job titles, job descriptions, job locations, functional areas of an entity, dates, and entity information,
scanning the records of the database, including any metadata that is associated with a record, to identify entities of interest;
scanning the records of the database, including any metadata that is associated with a record, to identify software products;
scanning the records of the database, including any metadata that is associated with a record, to identify locations associated with each entity of interest;
determining which of the software products identified in the scan are AI products using an AI product listing, said AI product listing comprising a listing of software products that have been previously identified as involving AI;
tag each database record containing a software product found to match an AI product as an AI product-containing record;
for each entity of interest,
computing an AI component that quantifies the level of use of AI technologies at the entity under consideration, said AI component computation comprising,
computing an AI product use factor which quantifies the use of AI products by the entity under consideration in terms of the AI technologies the AI products represent,
computing a percentage of locations associated with the entity under consideration, which are using at least one AI technology,
computing a percentage of functional areas of interest across all locations associated with the entity under consideration, which are using at least one AI technology, and
computing the AI component for the entity under consideration, said AI component computation comprising adding the square of the AI product use factor computed for the entity under consideration to the percentage of locations of the entity using at least one AI technology and the percentage of functional areas of interest associated with the entity using at least one AI technology to produce the AI component for the entity under consideration,
computing a data science component that quantifies the level of an entity's data science expertise on a location basis, said data science component computation comprising,
for each of the identified locations associated with the entity under consideration,
identifying the data-oriented roles of individuals working for the entity at that location,
determining how many different locations associated with the entity under consideration have at least one data-oriented role associated with it, and
dividing the number of locations that have at least one data-oriented role associated with it by the total number of locations associated with the entity to produce a percentage of an entity's locations associated with a data-oriented role,
determining the total number of each type of data-oriented role associated with the entity under consideration, regardless of location, and identify the data-oriented role having the highest total,
assigning a prescribed data-oriented role weight corresponding to the identified data-oriented role having the highest total to the entity under consideration, and
multiplying the data-oriented role weight assigned to the entity under consideration by the percentage of the entity's locations associated with a data-oriented role to produce the data science component for the entity under consideration,
computing a raw data maturity component that quantifies the degree to which the entity is involved in using data technologies, said raw data maturity component computation comprising,
generating a list of software products in use by the entity under consideration,
filtering the list of software products in use by the entity under consideration to retain those software products that are also found in a data mature products listing that lists the names of software products considered to be data mature products and a weight associated with each data mature product indicative of the level of pervasiveness of the product among entities deemed to be data mature, to produce a list of data mature products in use by the entity under consideration,
finding the weight associated with each of the data mature products in the list of data mature products using the data mature products listing and sum the discovered weights to produce a data maturity impact score for the entity under consideration,
determining how many different locations associated with the entity under consideration use at least one data mature product and dividing the number of different locations associated with the entity under consideration that use at least one data mature product by the total number of locations associated with the entity to produce the percentage of locations of the entity under consideration using at least one data mature product, and
multiplying the data maturity impact score computed for the entity under consideration by the percentage of locations of the entity under consideration using at least one data mature product to produce a raw data maturity component for the entity under consideration;
for each entity of interest, normalizing the raw data maturity component computed for entity under consideration in view of the raw data maturity components computed for all the entities of interest to produce the data maturity component for the entity under consideration;
for each entity of interest that has a non-zero AI component, computing an AI maturity score by summing the AI component, the data science component, and the data maturity component computed for the entity under consideration to produce the AI maturity score for the entity;
for each entity of interest that has a zeroed AI component, computing an AI maturity score by summing the data science component and the data maturity component computed for the entity under consideration and taking the square root of the sum to produce an AI maturity score for the entity under consideration; and
generating an AI maturity report comprising a listing of, for each entity of interest, the AI maturity score computed for that entity.

19. The process of claim 18, wherein the process action for computing the AI product use factor comprises:
accessing all the records associated with the entity under consideration that have been tagged as an AI product-containing record;
categorizing the accessed AI product-containing records according to the AI technology that the AI product found in the record belongs to using an AI technology listing, said AI technology listing comprising a listing of AI products and the AI technology the AI product belongs to; and
determining how many different AI technologies of interest are associated with the entity under consideration and dividing the number of AI technologies of interest associated with the entity by the total number of AI technologies of interest to produce an AI product use factor for the entity under consideration.

20. The process of claim 18, wherein the process action for generating the AI maturity report further comprises including a ranking number for each entity of interest, wherein the ranking number for each entity of interest indicates how high that entity's AI maturity score is in comparison to the AI maturity scores of all the entities of interest.
